(19) United States
(12) Patent Application Publication
(10) Pub. No.: US 2005/0154808 A1
(43) Pub. Date: Jul. 14, 2005

(54) Method, computer program, and apparatus for managing a plurality of active devices

(76) Inventors: Reiner Augusto Campillo Terrero, Santa Domingo (DM); Victor Arnable Herrera Liriano, Santo Domingo (DM)

Correspondence Address: BURNS DOANE SWECKER & MATHIS L L P, POST OFFICE BOX 1404, ALEXANDRIA, VA, 22313-1404, US

(21) Appl. No.: 10/754,566

(22) Filed: Jan. 12, 2004

(51) Int. Cl. G06F 13/12

(52) U.S. Cl. 710/72

(57) ABSTRACT

A plurality of active devices to be programmed/managed are connected via their management ports to a concentrator device. A communications port of the concentrator device is then connected to a computer. As a result, an operator can manage the plurality of active devices through a single communication port of the computer by selecting, manually or via software, the individual active device to manage. The concentrator device, upon receiving an indication of the active device to manage, establishes a link between its communication port and the management port associated with the selected active device. Alternatively, the operator can select a simultaneous mode wherein the concentrator device establishes a simultaneous link between the its communication port and each of its management ports associated with two or more selected devices. As a result, the operator can send commands to a group of the active devices simultaneously.

### FIELD OF THE INVENTION

The invention relates to management of active devices, and more specifically, to an apparatus, computer program, and method for managing a plurality of active devices via a communication protocol with an assigned physical port.

### BACKGROUND OF THE INVENTION

As systems comprising multiple electronic or active devices, such as routers, switches, bridges, hubs, firewalls, PLCs, ATMs, modems, power invertors, servers, PCs, and the like, became more and more common, the need for standard protocols for communicating with these devices became more and more evident. Accordingly, the industry established multiple standards, such as RS232 or USB to name two common protocols, for establishing communications with a vast array of active devices. In addition, numerous network protocols, such as http, html, and the OSI model, were also established for providing communication between multiple computers over what is commonly referred to as the Web.

A great number of active devices come with a management and/or programming port, in addition to input/output ports of normal operation, which allow the device to be managed remotely from a computer or network. These management ports allow system operations to manage the devices by communicating with the device via a communications protocol with an assigned physical port. For example, the active device can be connected to a computer as illustrated in FIG. 1.

As shown in FIG. 1, the management port 130a of active device 150a is connected to computer 100 via the computer's communication port 110. This configuration allows a system operator to manage the active device by, for example, downloading new firmware into the device, or changing the operational parameters of the device. However, as shown in FIG. 1, for the operator to manage both actives devices 150a, 150b, the physical connection between the computer 100 and active device 150a must be broken and re-established with the second or additional active device 150b. In addition to the time required to reconfigure the system, this method of managing multiple active devices requires an operator or technication to be in close proximity with the active devices in order to physically reconfigure the connections. Although this may result in mere inconvenience for small systems, it becomes an impossible requirement for large distributed systems, for example telecommunications system which utilize hundreds of configureable routers and/or switching devices located in a large geographical area.

To solve this problem, several products have been developed, for example Neteon Technologies' serial to Ethernet line of products, Cisco's 2500 series access servers or the Neteon Technologies multi-serial card line of products. However, these devices require either installation of a card into the computer 100, establishment of a network session, or both. Those devices which require utilization of network resources have the disadvantage of allowing the risk of someone being able to access the active devices from the network without authorization which results in having to invest in more security resources. Furthermore, these devices can degrade the network to which they are connected. Those devices which require installation of a card, in addition to the card consuming processing resources and memory, have the disadvantage of being limited in use to those computers in which the required card is installed.

Accordingly, prior to the present invention, a need existed for a device capable of providing secure communication with a plurality of active devices without requiring reconfiguration of computing resources.

### OBJECTS AND SUMMARY

The invention overcomes the above identified drawbacks by providing a device, computer program, and method for managing a plurality of active devices in a secure and flexible manner.

According to one embodiment of the invention, a concentrator device is provided that allows a plurality of active devices to be independently and simultaneously connected to the device through independent programming or management ports. The concentrator device is then connected to the communication port of a computer, allowing an operator to manage the plurality of active devices via a single computer interface.

Management of the active devices is achieved, in accordance with one embodiment of the invention, by selecting the active device to be managed, for example, by pressing a button on the concentrator device or selecting an active device from a user interface within the computer. The concentrator device upon receiving an indication of the selected active device establishes a link between the communication port of the concentrator device and the management port associated with the selected active device.

According to another embodiment of the invention, an operator can select to manage the active devices in a simultaneous mode. In simultaneous mode, the concentrator device establishes a simultaneous link between the communication port of the concentrator device and two or more of the active devices.

### BRIEF DESCRIPTION OF THE DRAWING FIGURES

A more complete understanding of the present invention may be derived by referring to the detailed description and claims when considered in connection with the Figures, wherein like reference numbers refer to similar items throughout the Figures.

FIG. 1 illustrates an existing method for managing active devices.

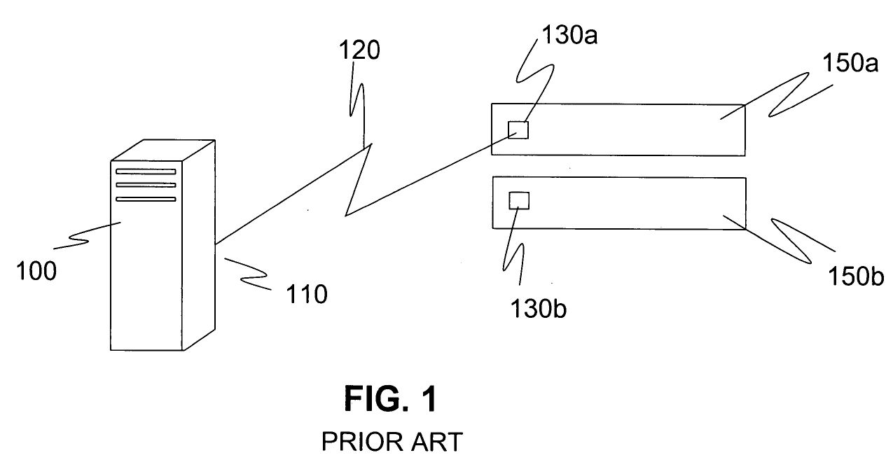

FIG. 2 illustrates a method of connecting a plurality of active devices with a computer according to an exemplary embodiment of the invention.

FIG. 3 illustrates a block diagram of the concentrator device according to an exemplary embodiment of the invention.

FIG. 4 illustrates an exemplary method of selecting an active device to manage according to the invention.

FIG. 5 illustrates another exemplary method of selecting an active device to manage according to the invention.

### DETAILED DESCRIPTION OF THE INVENTION

In the following description, for purposes of explanation and not limitation, specific details are set forth, such as particular circuits, circuit components, techniques, etc. in order to provide a thorough understanding of the present invention. However, it will be apparent to one of ordinary skill in the art that the present invention may be practiced in other embodiments that depart from these specific details. In other instances, detailed descriptions of well-known methods, devices, and circuits are omitted so as not to obscure the description of the present invention with unnecessary detail.

These and other aspects of the invention will now be described in greater detail in connection with a number of exemplary embodiments. To facilitate an understanding of the invention, many aspects of the invention are described in terms of sequences of actions to be performed by elements of a computer system. It will be recognized that in each of the embodiments, the various actions could be performed by specialized circuits, by program instructions being executed by one or more processors, or by a combination of both. Thus, the various aspects of the invention may be embodied in many different forms, and all such forms are contemplated to be within the scope of the invention. For each of the various aspects of the invention, any such form of embodiment may be referred to herein as “logic configured to” perform a described action.

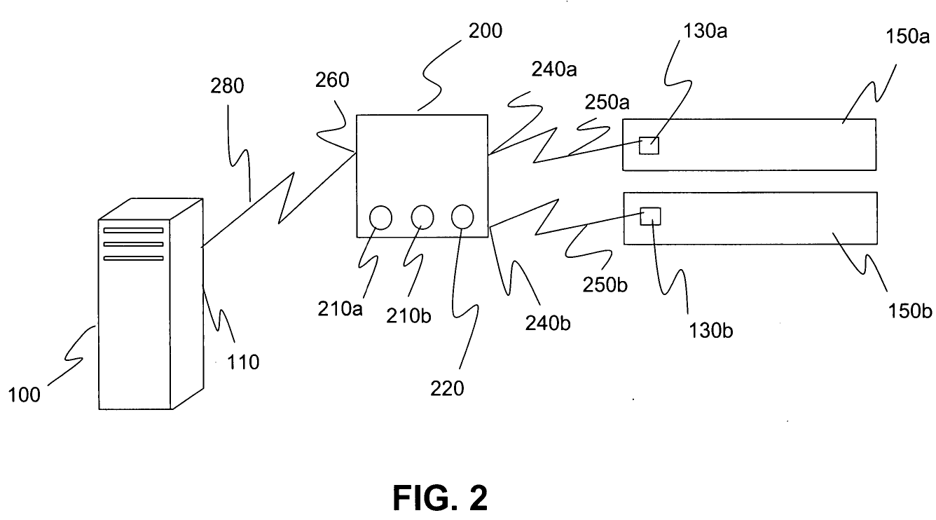

According to an exemplary embodiment of the invention, multiple active devices are connected to a concentrator device 200 which is connected to a computer 100. As illustrated in FIG. 2, the management port 130a, 130b of each active device 150a, 150b is directly connected to physical ports 240a, 240b in the concentrator device 200. Directly connected in this situation refers to the fact that there must be a physical port for each active device to be managed. The concentrator device 200 is also connected, via its communication port 260 to computer 100. As a result computer 100 can communicate with any of the active devices 150a, 150b connected to the concentrator device 200 through a single communication line 280.

The concentrator device 200, in accordance with an exemplary embodiment of the invention, does not require installation and/or configuration of software (except if software selection is utilized as described below), establishment of sessions, installation of jumpers, switches, or any other physical installation inside the computer 100. Furthermore, when the active devices correspond to layer 1, layer 2 and/or layer 3 of the OSI model, the concentrator device does not depend on any network resources for its operation. For example, the concentrator device does not depend on connection to the network, quantity of hosts, network addresses, quantity of networks, bandwidth, LAN technology, WAN technology, network topology, layer 2 and/or 3 protocol, and/or any other elements of the network.

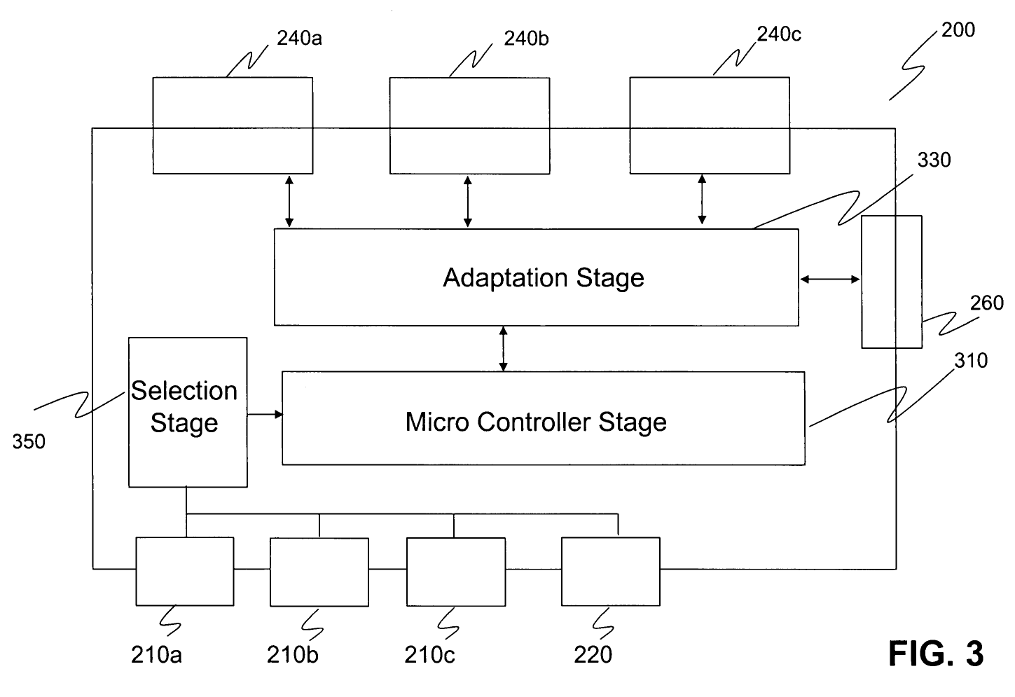

As illustrated in FIG. 3, the concentrator device 200 comprises a plurality of physical ports 240a-240c (“management ports”), a communications port 260 and a plurality of switches or buttons 210a-210c and 220. Although any number of management ports and switches can be employed in the invention, there is preferably at least one switch associated with each management port.

The concentrator device 200 further comprises logic configured to establish a link between the communications port 260 and any one or all of the management ports 240a-240c. This logic is illustrated in FIG. 3 as three separate stages, an adaptation stage 330, a selection stage 350 and a micro controller stage 310. However it should be noted that this segmentation is purely for illustrative purposes and is not intended to limit the invention in any manner.

The adaptation stage 330, in addition to amplifying the signals passing through the concentrator device, modifies the signals received from the communication port to meet the protocol of the selected management port. For example, if the selected management port communicates with the active device using a USB or RS232 connection, then the adaptation stage would include the drivers required to conform the signal received from the communications port to the USB or RS232 standard as appropriate. Likewise, the adaptation stage adapts the signals received from the management ports to conform to the standard of the communication port 260.

The selection stage 350 provides a signal to the micro controller indicating which active device has been manually selected by the operator. The micro controller stage (herein “controller”) establishes the link between the communication port and the selected management port based on the signal received from the selection stage.

Communication between the computer 100 and any one of the active devices 150a, 150b is achieved, according to one embodiment of the invention, by the user selecting the switch 210a-210b corresponding to the desired active device. For example, switch 210a is associated with management port 240a, and switch 210b, is associated with management port 240b. Therefore, if the operator wishes to manage the active device 150b connected to management port 240b then he would select switch 210b. Alternatively, if the operator selects switch 220, then the concentrator device is placed in simultaneous mode, wherein the controller 310 establishes a simultaneous link between the management ports selected afterward and the communication port. As a result, in simultaneous mode, the signal sent to communication port 260 is routed to every selected active device simultaneously.

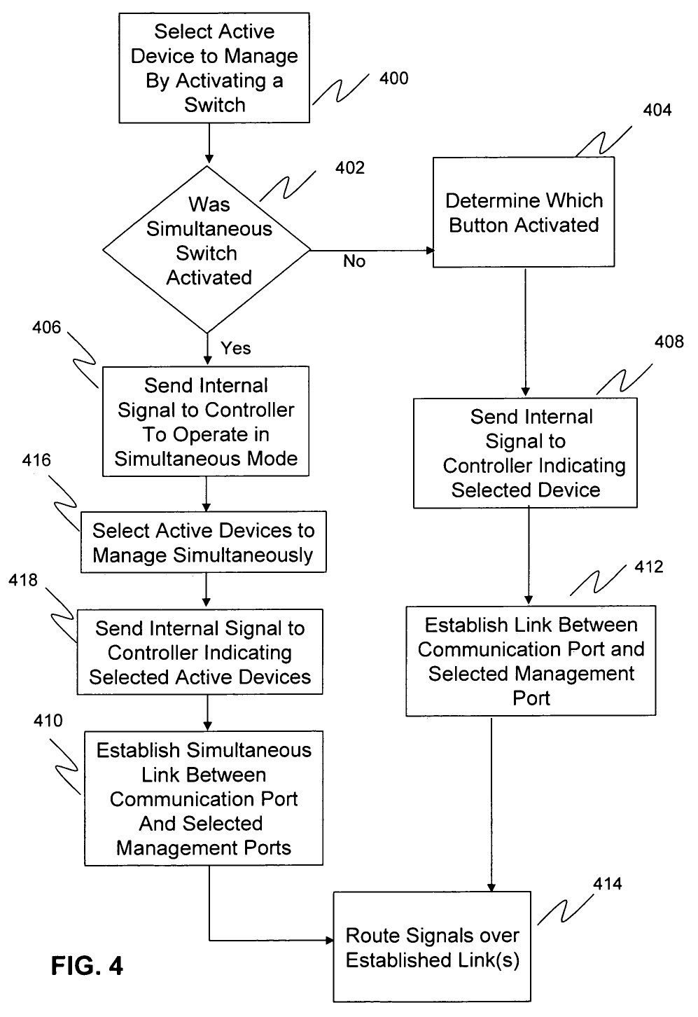

As illustrated in the flow chart of FIG. 4, management of an active device begins with selection of the active device or devices to manage by activating one of a plurality of switches at step 400. At step 402, it is determined whether or not the simultaneous mode switch has been activated. If the simultaneous mode switch has been activated (YES branch out of decision block 402), the selection logic sends an internal signal to the controller, at step 406, indicating the simultaneous mode. Control then proceeds to step 416 where the active devices to be managed simultaneously are selected. An internal signal indicating the selected active devices is then sent to the controller at step 418. The controller then establishes a simultaneous link between the communications port and the management ports associated with the selected active devices at step 410. If the simultaneous switch has not been selected (NO branch out of decision block 402), then the selection logic within the concentrator device determines which switch has been activated at step 404 and sends an internal signal to the controller at step 408, indicating the selected management port. The controller then establishes a link between the communication port and the selected management port at step 412. Finally, at step 414, the signals received at the communication port and the management ports are routed through the device along the established links.

According to another embodiment of the invention, selection of an active device can be achieved through software contained in computer 100. This allows an operator, through any number of known user interface options, such as a menu, list, graphic representation of the system and the like, to select the desired active device or a group of the devices simultaneously that they wish to manage. Upon selection of one or a group of the active devices the software sends a control signal to the micro controller 310. The micro controller logic then establishes a link between the communication port 260 and the management port(s) associated with the selected active device or devices.

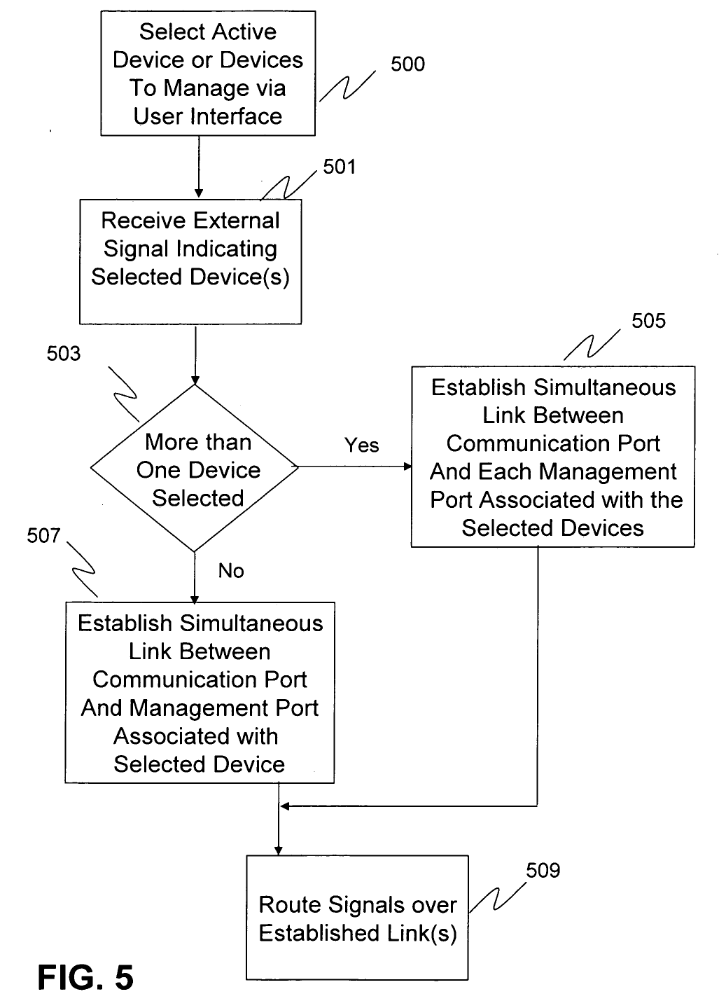

As illustrated in FIG. 5, as with the previous embodiment, management of the active devices begins with the selection of the devices to manage at step 500. At step 501, the controller receives an external signal indicating the selected active device or devices. The controller then determines, at step 503, whether or not simultaneous mode has been selected. If simultaneous mode as been selected (YES branch out of decision block 503) the controller establishes, at step 505, a simultaneous link between the communication port and the management ports associated with each of the selected active devices. If simultaneous mode was not selected (NO branch out of decision block 503), the controller establishes, at step 507, a link between the communication port and the management port associated with the selected active device. Finally, at step 509, the signals received at the communication port and the management ports of the concentrator device are routed through the device along the established links

The invention has been described with reference to particular embodiments. However, it will be readily apparent to those skilled in the art that it is possible to embody the invention in specific forms other than those of the preferred embodiments described above. This may be done without departing from the spirit of the invention.

For example, the invention refers to active devices that comprise a separate programing/management port. However, this is not essential. Rather, the active device may have a physical port which commonly functions as an input/output port and a management/programming port.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

1. A method of managing a plurality of active devices, wherein the active devices include a management port which is connected to a management port of a concentrator device and a communication port of the concentrator device is connected to a communication port of a computer, the method comprising the steps of:
selecting the active device to manage;
establishing a link between the communication port of the concentrator device and the management port of the concentrator device associated with the selected active device; and
communicating with the selected active device from the computer.

2. The method of claim 1, wherein selecting the active devices to manage comprises:
manually activating a switch associated with the management port with which the desired active device is connected.

3. The method of claim 1, wherein selecting the active devices to manage comprises:
selecting the desired active device through a user interface on the computer; and
sending a signal to the concentrator device indicating the selected active device.

4. The method of claim 1, further comprising the steps of:
receiving a signal to operate the concentrator device in simultaneous mode; and
establishing a simultaneous link between the communications port of the concentrator device and each of the selected management ports of the concentrator device.

5. The method of claim 4, wherein selecting the active device to manage comprises:
manually activating a switch associated with the simultaneous mode.

6. The method of claim 1, wherein the plurality of management ports support the same protocol.

7. The method of claim 1, wherein the communication port of the concentrator device and the plurality of management ports support different protocols.

8. An apparatus for managing multiple active devices, the apparatus comprising:
at least one communication port;
a plurality of management ports;
a plurality of switches; and
a microprocessor configured to establish a link between the communication port and at least one selected management port.

9. The device of claim 8, wherein the microprocessor is configured to receive an external signal indicating the selected management port.

10. The device of claim 8, wherein the microprocessor is configured to receive an internal signal indicating the selected management port, wherein the internal signal is generated based on the activation of one of said plurality of switches.

11. The device of claim 8, wherein the microprocessor is configured to establish a simultaneous link between the communication port and two or more of the plurality of management ports.

12. The device of claim 8, wherein the plurality of management ports support the same protocol.

13. The device of claim 12, wherein the communication port and the plurality of management ports support different protocols.

14. A system for managing a plurality of active devices, the system comprising:
a plurality of active devices;
a concentrator device, the concentrator device comprising at least one communication port, a plurality of management ports, and a microprocessor, wherein the microprocessor is configured to:
receive an external signal indicating a selected active device; and
establish a link between the communication port and the management port associated with the selected active device;
a computer, the computer comprising a user interface configured to:
receive an indication of the active device to be managed; and
send a signal to the concentrator device indicating the active device selected to be managed; and
wherein each of the plurality of active devices are connected to a management port of the concentrator device and a communication port of the concentrator device is connected to a communication port of the computer.

15. A computer readable medium comprising executable code, the executable code configured to:
send signals to a concentrator device;
receive signals from the concentrator device;
receive an indication of one or more active devices to be managed; and
wherein at least one of the signals sent to the concentrator device indicates one or more active devices to be managed.

16. The computer readable medium of claim 15, wherein at least one of the signals received from the concentrator device provided information regarding establishment of a link between a communication port and a manage port of the concentrator device.

17. The computer readable medium of claim 15, wherein at least one of the signals received from the concentrator device initiated in one of a plurality of active devices connected to the concentrator device.

18. The computer readable medium of claim 15, wherein at least one of the signals sent to the concentrator device is passed to one or more of a plurality of active devices connected to the concentrator device.
